(19) United States
(12) Patent Application Publication
(10) Pub. No.: US 2021/0207670 A1
(43) Pub. Date: Jul. 8, 2021

(54) BRAKE DISC AND MANUFACTURING METHOD THEREOF

(71) Applicant: NINGBO HIGHRISE NEW MATERIAL CO.,LTD., Zhejiang (CN)

(72) Inventors: Lin QI, Zhejiang (CN); Pixiang QI, Zhejiang (CN)

(73) Assignee: NINGBO HIGHRISE NEW MATERIAL CO.,LTD., Zhejiang (CN)

(21) Appl. No.: 16/071,075

(22) PCT Filed: Nov. 27, 2017
(86) PCT No.: PCT/CN2017/000701

§ 371 Date: Jul. 19, 2018

(30) Foreign Application Priority Data
Nov. 13, 2017 (CN) 201711111775.6

(51) Int. Cl. F16D 65/12; B22D 18/02

(52) U.S. Cl. CPC F16D 65/125; F16D 69/023; B22D 18/02

(57) ABSTRACT

A brake disc used for brake systems of motor vehicles, rail vehicles and aircrafts and the brake disc includes a brake disc body, wherein the brake disc body is an aluminum alloy brake disc body, the two working surfaces of the aluminum alloy brake disc body are respectively attached with a wear-resistant layer, the wear-resistant layers are wear-resistant layers made of ceramic high-temperature resistant metal matrix composite (MMC) reinforced materials, and the wear-resistant layers made of ceramic high-temperature resistant MMC reinforced materials metallurgically bond with the aluminum alloy brake disc body through a squeeze casting technique.

### BACKGROUND

### Technical Field

The invention relates to a key part of brake systems of motor vehicles, rail vehicles, aircrafts and the like, in particular to a brake disc and a manufacturing method thereof.

### Description of Related Art

Brake discs are important safety parts of motor vehicles, rail vehicles and aircrafts. Mechanical energy is converted into heat energy through friction between the brake discs and brake pads so as to stop the wheels from running, and therefore, reliable braking is of great importance. If braking fails in emergency circumstances, safety accidents can be caused, and even car crashes can be caused. For this reason, the brake discs are extremely important safety parts. At present, as the concept of energy conservation, environmental friendliness and lightweight has become the important development direction of motor vehicles, rail vehicles and aircrafts, lightweight of the brake discs is of more important significance. As the weight of the brake discs belongs to the unsprung weight, research shows that the weight reduction effect of the brake discs is three to five times that of the sprung weight.

At present, mainly two types of brake discs are used in China and foreign countries, namely nodular cast iron brake discs (nodular cast iron discs for short) which are widely applied to motor vehicles and rail vehicles, and carbon fiber ceramic brake discs (carbon fiber ceramic discs for short) which are applied to luxury motor vehicles and aircrafts. The nodular cast iron discs are integrally made of nodular cast iron materials by gravity casting and have good wear-resistance and mechanical performance, the casting technique for the nodular cast iron discs is mature, and the nodular cast iron discs can be provided with complex ventilation holes and are low in price and suitable for mass production. The carbon fiber ceramic discs obtained after carbon fiber materials are immersed in resin glue and then cured at a high temperature and are extremely expensive, thereby only being applied to aircrafts and a few of luxury vehicles.

The nodular cast iron discs have the following defects. Firstly, the density of nodular cast iron is high and reaches about 7.3 g/cm³, for example, the weight of one brake disc, with the diameter 355 mm, applied to a vehicle reaches about 11.78 Kg (equivalent to the sprung weight 35.34-58.9 Kg); as one vehicle needs four brake discs, the sprung weight of the vehicle is extremely high, oil consumption of the vehicle will be increased undoubtedly, and the maneuverability of the vehicle is reduced; and relevant component are difficult to assemble, disassemble and maintain. Secondly, heat conductivity of cast iron is poor, frictional heat generated in the braking process is dissipated slowly, and consequentially, failures of brake systems are likely to be caused due to excessive temperature rise. Thirdly, the cast iron brake discs are generally cast by sand casting, the dimensional accuracy and roughness of surface of the castings are poor, the shrinkage and porosity of the castings are difficult to control, energy consumption for casting is high, and pollution to the environment is severe.

Although the weight of the carbon fiber ceramic discs is only about half that of the nodular cast iron discs, the raw materials of the carbon fiber ceramic discs are expensive and the manufacturing device and technique for the carbon fiber ceramic discs are complex, and thus the price of the carbon fiber ceramic discs is over 50 times that of the nodular cast iron discs.

In conclusion, brake discs which are safer, more reliable, low in weight, long in service life and low in use cost are urgently needed to be developed for the development of industries of motor vehicles, rail vehicles and aircrafts at present.

### SUMMARY

To overcome the defects of the prior art, the invention provides a brake disc and a manufacturing method thereof. The brake disc meets the brake requirements of brake systems of motor vehicles, rail vehicles, aircrafts and the like in performance, approximates to carbon fiber ceramic discs in weight and service life, has the service life over 300,000 kilometers, approximates to nodular cast iron discs in use cost, and is suitable for automatic mass production.

According to the technical scheme adopted by the invention: a brake disc is used for brake systems of motor vehicles, rail vehicles and aircrafts and includes a brake disc body, wherein the brake disc body is an aluminum alloy brake disc body, the two working surfaces of the aluminum alloy brake disc body are each attached with a wear-resistant layer, the wear-resistant layers are made of ceramic high-temperature resistant metal matrix composite (MMC) reinforced materials, and the wear-resistant layers made of ceramic high-temperature resistant MMC reinforced materials metallurgically bond with the aluminum alloy brake disc body through the squeeze casting technique. The ceramic high-temperature resistant MMC reinforced material is manufacturing from ceramic fiber materials, high-temperature resistant skeleton metal materials and ceramic particle materials, and the mass ratio of the ceramic fiber materials, the high-temperature resistant skeleton metal materials and the ceramic particle materials is (1-30):(10-60):(10-70). The ceramic fiber materials include one or more of alumina fibers, alumina silicate fibers, silicon dioxide fibers, zirconium oxide fibers, silicon carbide fibers, graphite fibers and carbon fibers. The high-temperature resistant skeleton metal materials are foam metal or high-temperature resistant metal fibers. The high-temperature resistant metal fibers include one or more of fe-based alloy fibers, nickel-based alloy fibers, copper-based alloy fibers, stainless steel fibers, steel wool fibers, titanium-based alloy fibers and cobalt-based alloy fibers. The ceramic particle materials include one or more of flyash particles, superfine slag powder particles, silicon carbide particles, silicon dioxide particles, boron nitride particles, zircon powder particles, brown fused alumina particles, zirconium oxide particles, zirconium silicate particles and chromic oxide particles.

The brake disc body of the brake disc of the invention is made of aluminum alloy, the density of aluminum alloy is low, and thus the weight of the brake disc can be greatly reduced. Compared with traditional cast iron brake discs of the same size and type, the weight of the brake disc of the invention can be reduced by over 50%, so that the effective load of motor vehicles, rail vehicles and aircrafts is increased, and oil consumption is reduced. The brake disc of the invention is locally reinforced selectively, the two working surfaces of the aluminum alloy brake disc body are each attached with one wear-resistant layer, and the wear-resistant layers are made of ceramic high-temperature resistant MMC reinforced materials, so that the wear-resistance of the brake disc is superior to that of cast iron brake discs, the dimensional accuracy of the brake disc is easy to control, the service life of the brake disc is prolonged, it is ensured that the service life of the brake disc is over 300,000 kilometers, and the raw material cost and the machining cost of the brake disc are reduced; and meanwhile, the heat conductivity of aluminum alloy is obviously superior to that of cast iron, and thus the heat dissipation performance of the brake disc can be improved. Through the high-temperature resistant skeleton metal materials, the high-temperature resistant strength and tenacity of the brake disc can be improved, the thermal expansivity of the brake disc can be reduced, and stress deformation of the brake disc under high temperature conditions is avoided. The brake disc is low in weight, high in strength, good in wear-resistance and heat dissipation performance, long in service life, approximate to carbon fiber ceramic discs in weight and life, low in machining cost and maintenance cost, approximate to nodular cast iron discs in use cost, capable of improving the trafficability of motor vehicles, rail vehicles and aircrafts, shortening the brake distance and improving safety, and suitable for automatic mass production.

Preferably, the two wear-resistant layers are each in the shape of an integrated plate or in the shape of a plate formed by a plurality of sub-plates which are spliced together. The two wear-resistant layers are connected up and down through a supporting rib. The supporting rib is made of high-temperature resistant skeleton metal materials. The two wear-resistant layers and the supporting rib metallurgically bond with the aluminum alloy brake disc body through the squeeze casting technique. Through the supporting rib, the contact area and the connection strength between the wear-resistant layers and the aluminum alloy brake disc body can be improved, and the wear-resistant effect of the wear-resistant layers is ensured.

Furthermore, the supporting rib includes a plurality of supporting units. The upper portion and the lower portion of each supporting unit are each integrally provided with a plurality of connecting tips. A plurality of insertion holes, matched with the multiple connecting tips, are formed in the two wear-resistant layers. Each connecting tip is inserted into one insertion hole. The multiple supporting units are arranged at intervals in the circumferential direction of the two wear-resistant layers.

Or, the aluminum alloy brake disc body is a ventilated brake disc body and includes an outer brake disc body and an inner brake disc body. The outer brake disc body and the inner brake disc body are connected through a connecting rib. The working surfaces of the outer brake disc body and the inner brake disc body are each attached with one wear-resistant layer.

Preferably, auxiliary reinforcing particles are mixed in the ceramic particle materials which are graphite particles and/or steel slag particles.

Furthermore, the steel slag particles can be one or more of iron oxide particles, zinc oxide particles, calcium oxide particles, magnesium oxide particles, aluminum oxide particles and titanium oxide particles.

Preferably, the foam metal is foam copper, foam iron, foam nickel or foam iron-nickel.

Preferably, the diameter of the ceramic fiber materials is 5-15 m, and the length of the ceramic fiber materials is 0.8-2.8 mm. The diameter of the high-temperature resistant metal fibers is 0.01-2 mm. The granularity of the ceramic particle materials is 5-200 μm, and the Mohs hardness of the ceramic particle materials is 5-9. The porosity of the foam metal is 10-60 ppm.

Preferably, the thickness of the wear-resistant layers is 2-15 mm. The wear-resistant layers with the proper thickness are selected so that cost can be reduced while the overall heat conductivity, wear-resistance and service life of the brake disc are ensured.

Or, squeeze casting is replaced with environment-friendly sand mold casting, vacuum die casting, centrifugal casting, low pressure casting, differential pressure casting, metal mold casting, investment casting, lost foam casting or vacuum suction casting. Besides squeeze casting, the wear-resistant layers made of ceramic high-temperature resistant composite reinforced materials can also metallurgically bond with the aluminum alloy brake disc body through other casting techniques such as environment-friendly sand mold casting, vacuum die casting, centrifugal casting, low pressure casting, differential pressure casting, metal mold casting, investment casting, lost foam casting and vacuum suction casting.

The manufacturing method of the brake disc includes the following steps:

1) Raw materials are prepared, by mass, dry ceramic fiber materials, high-temperature resistant skeleton metal materials and ceramic particle materials are prepared according to the mass ratio (1-30):(10-60):(10-70).

2) High-temperature resistant skeleton metal preforms are manufactured, specifically, foam metal is machined into two plates which are matched with the wear-resistant layers in shape and size, so that the high-temperature resistant skeleton metal preforms are obtained; or high-temperature resistant metal fibers are evenly spread in a mold matched with the wear-resistant layers in shape and size in twice and then compacted, so that two high-temperature resistant skeleton metal preforms are obtained.

3) Preforms of the wear-resistant layers made of ceramic high-temperature resistant MMC reinforced materials are manufactured, specifically, the high-temperature resistant skeleton metal preforms obtained in Step 2) are placed in a preform mold, the ceramic fiber materials and the ceramic particle materials prepared in Step 1) are evenly mixed with a low-temperature binding agent and a high-temperature binding agent according to the mass ratio (1-30):(10-70):(0.5-8):(0.5-10), and thus ceramic slurry is obtained, wherein the low-temperature binding agent is a carboxymethylcellulose aqueous solution with the concentration 3-20%, and the high-temperature binding agent is a silica sol solution with the concentration 10-60%; the obtained ceramic slurry is then poured into the preform mold, the preform mold is pressurized to 20-30 MPa and vacuumized to 1*10⁻² Pa, and semi-finished preforms of the wear-resistant layers made of ceramic high-temperature resistant metal composite reinforced materials are formed through dewatering and pressing; and afterwards, the semi-finished preforms are dried at the temperature 60-200° C. for 10-20 h and sintered at the temperature 700-1000° C. for 2.5-4 h, and thus finished preforms of the wear-resistant layers made of ceramic high-temperature resistant metal composite reinforced materials are obtained.

4) The finished preforms of the wear-resistant layers made of ceramic high-temperature resistant MMC reinforced materials obtained in Step 3) are placed in the lower mold part of a squeeze casting mold, then aluminum alloy is smelted, the molten aluminum alloy is then poured into the lower mold part of the squeeze casting mold matched with the brake disc in size and shape, afterwards, the upper mold part and the lower mold part of the squeeze casting mold are closed for squeeze casting at the pressure 50-150 MPa, the temperature of the upper mold part and the lower mold part is 100-250° C., the pressure is maintained for 10-60 seconds after the upper mold part and the lower mold part are assembled, then the mold is opened, and a brake disc casting is taken out of the mold and obtained.

5) The brake disc casting obtained in Step 4) is subjected to solution treatment at the temperature 480-535° C. and kept at the temperature for 5-7 h, the brake disc casting is then quenched in water at the temperature over 60° C., and finally the brake disc casting is subjected to aging treatment at the temperature 150-180° C. and kept at the temperature for 4-8 h, and thus a semi-finished brake disc is obtained.

6) The semi-finished brake disc is machined, specifically, the finished brake disc is manufactured after the semi-finished brake disc is machined according to drawing requirements.

Compared with the prior art, the invention has the following advantages:

1. The brake disc body of the brake disc of the invention is made of aluminum alloy, the density of aluminum alloy is low, and thus the weight of the brake disc can be greatly reduced. Compared with traditional cast iron brake discs of the same size and type, the weight of the brake disc can be reduced by over 50%, so that the effective load of motor vehicles, rail vehicles and aircrafts is increased, and oil consumption is lowered.

2. The brake disc of the invention is locally reinforced selectively, the two working surfaces of the aluminum alloy brake disc body are each attached with one wear-resistant layer, and the wear-resistant layers are made of ceramic high-temperature resistant MMC reinforced materials, so that the wear-resistance of the brake disc is superior to that of cast iron brake discs, the dimensional accuracy of the brake disc is easy to control, the service life of the brake disc is prolonged, it is ensured that the service life of the brake disc is over 300,000 kilometers, and the raw material cost and the machining cost of the brake disc are reduced; and meanwhile, the heat conductivity of aluminum alloy is obviously superior to that of cast iron, and thus the heat dissipation performance of the brake disc can be improved.

3. The strength of the high-temperature resistant skeleton preforms is high, so that the high-temperature resistant skeleton preforms are not prone to breaking or fracturing in the assembling and transferring process and can bear the high temperature over 600° C., deformation of the high-temperature resistant skeleton preforms in the squeeze casting process is reduced, and thus the rate of finished brake discs is increased greatly.

4. Through the high-temperature resistant skeleton metal materials, the high-temperature resistant strength and tenacity of the brake disc can be improved, the thermal expansivity of the brake disc can be reduced, and high-temperature resistant deformation of the brake disc in the operating process is reduced. The wear-resistance of the brake disc can be improved through the ceramic fiber materials and the ceramic particle materials.

5. The brake disc of the invention is low in weight, high in strength, good in wear-resistance and heat dissipation performance, long in service life, approximate to carbon fiber ceramic discs in weight and life, low in machining cost and maintenance cost, approximate to nodular cast iron discs in use cost, capable of improving the trafficability of motor vehicles, rail vehicles and aircrafts, shortening the brake distance and improving safety, and suitable for automatic mass production.

### BRIEF DESCRIPTION OF THE DRAWINGS

FIG. 1 is a top view of a brake disc in the first embodiment;

FIG. 2 is an A-A sectional view of FIG. 1;

FIG. 3 is a connection diagram of two wear-resistant layers in the first embodiment;

FIG. 4 is a structural diagram of a brake disc in the second embodiment.

### DESCRIPTION OF THE EMBODIMENTS

A further detailed description of the invention is given with accompanying drawings and embodiments as follows.

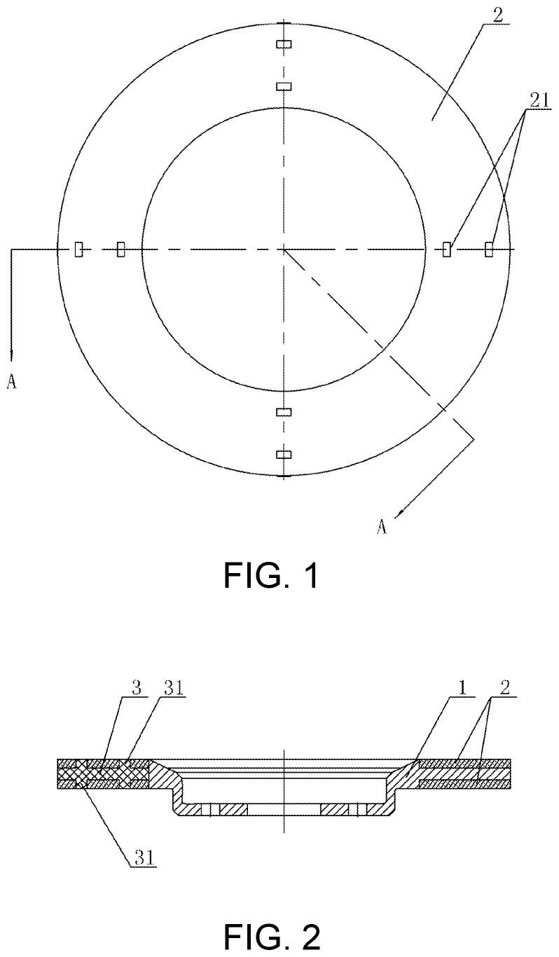

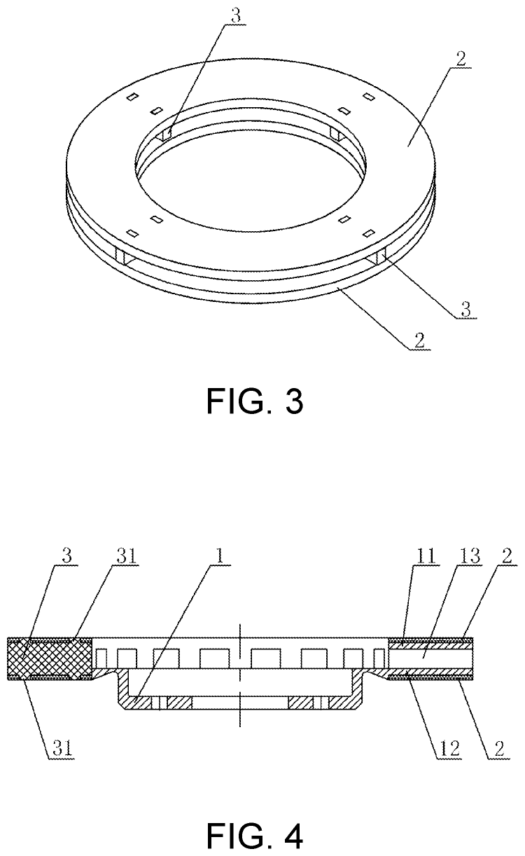

First embodiment: with a solid automotive brake disc as an example, as is shown in FIGS. 1-3, the brake disc includes a brake disc body 1. The brake disc body 1 is an aluminum alloy brake disc body 1, the two working surfaces of the aluminum alloy brake disc body 1 are each attached with a wear-resistant layer 2 with the thickness 12 mm, the wear-resistant layers 2 are made of ceramic high-temperature resistant MMC reinforced materials, and the wear-resistant layers 2 made of ceramic high-temperature resistant MMC reinforced materials are metallurgical bond with the aluminum alloy brake disc body 1 through the squeeze casting technique.

In the first embodiment, the two wear-resistant layers 2 are each in the shape of an integrated plate and are connected up and down through a supporting rib, and the supporting rib is made of high-temperature resistant skeleton metal materials. The two wear-resistant layers 2 and the supporting rib are metallurgical bond with the aluminum alloy brake disc body 1 through the squeeze casting technique. The supporting rib includes four supporting units 3. The upper portion and the lower portion of each supporting unit 3 are each integrally provided with two connecting tips 31. Insertion holes 21 matched with the connecting tips 31 are formed in the two wear-resistant layers 2. Each connecting tip 31 is inserted into one insertion hole 21. The four supporting units 3 are arranged at intervals in the circumferential direction of the two wear-resistant layers 2.

In the first embodiment, the ceramic high-temperature resistant MMC reinforced material is manufacturing from ceramic fiber materials, high-temperature resistant skeleton metal materials and ceramic particle materials, and the mass ratio of the ceramic fiber materials, the high-temperature resistant skeleton metal materials and the ceramic particle materials is 25:20:48. The ceramic fiber materials include one or more of alumina fibers, alumina silicate fibers, silicon dioxide fibers, zirconium oxide fibers, silicon carbide fibers, graphite fibers and carbon fibers. The high-temperature resistant skeleton metal materials are foam copper plates of a three-dimensional net structure. The ceramic particle materials include one or more of flyash particles, superfine slag powder particles, silicon carbide particles, silicon dioxide particles, boron nitride particles, zircon powder particles, brown fused alumina particles, zirconium oxide particles, zirconium silicate particles and chromic oxide particles. The diameter of the ceramic fiber materials is 5-15 μm, and the length of the ceramic fiber materials is 0.8-2.8 mm. The granularity of the ceramic fiber particle materials is 5-200 μm, and the Mohs hardness of the ceramic fiber particle materials is 5-9. The porosity of foam copper is 10-60 ppm.

The manufacturing method of the solid automotive brake disc includes the following steps:

1) Raw materials are prepared, by mass, dry ceramic fiber materials, high-temperature resistant skeleton metal materials and ceramic particle materials are prepared according to the mass ratio 25:20:48.

2) High-temperature resistant skeleton metal preforms are manufactured as follows, foam copper is machined into two plates which are matched with the wear-resistant layers in shape and size, and thus the High-temperature resistant skeleton metal preforms are obtained.

3) Preforms of the wear-resistant layers made of ceramic high-temperature resistant MMC reinforced materials are manufactured, specifically, the high-temperature resistant skeleton metal preform obtained in Step 2) are placed in a preform mold, the ceramic fiber materials and the ceramic particle materials prepared in Step 1) are evenly mixed with a low-temperature binding agent and a high-temperature binding agent according to the mass ratio 25:48:3:4, and thus ceramic slurry is obtained, wherein the low-temperature binding agent is a carboxymethylcellulose aqueous solution with the concentration 15%, and the high-temperature binding agent is a silica sol solution with the concentration 40%; the obtained ceramic slurry is then poured into the preform mold, the preform mold is pressurized to 25 MPa and vacuumized to 1*10-2 Pa, and semi-finished preforms of the wear-resistant layers made of ceramic high-temperature resistant MMC reinforced materials are formed through dewatering and pressing; and afterwards, the semi-finished preforms are dried at the temperature of 120° C. for 12 h and sintered at the temperature of 800° C. for 3 h, and thus finished preforms of the wear-resistant layers made of ceramic high-temperature resistant MMC reinforced materials are obtained.

4) The finished preforms of the wear-resistant layers made of ceramic high-temperature resistant MMC reinforced materials obtained in Step 3) are placed in the lower mold part of a squeeze casting mold, then aluminum alloy is smelted, the molten aluminum alloy is then poured into the lower mold part of the squeeze casting mold matched with the brake disc in size and shape, afterwards, the upper mold part and the lower mold part of the squeeze casting mold are assembled for skeleton metal preform squeeze casting at the pressure 100 MPa, the temperature of the upper mold part and the lower mold part is 180° C., the pressure is maintained for 60 seconds after the upper mold part and the lower mold part are closed, then the mold is opened, and a brake disc casting is taken out of the mold and obtained.

5) The brake disc casting obtained in Step 4) is subjected to solution treatment at the temperature 515° C. and kept at the temperature for 6 h, the brake disc casting is then quenched in water at the temperature over 60° C., and finally the brake disc casting is subjected to aging treatment at the temperature 170° C. and kept at the temperature for 6 h, and thus a semi-finished brake disc is obtained.

6) The semi-finished brake disc is machined, specifically, the finished solid automotive brake disc is manufactured after the semi-finished brake disc is machined according to drawing requirements.

Second Embodiment: with a ventilated automotive brake disc as an example, as is shown in FIG. 4, the brake disc includes a brake disc body 1, and the brake disc body 1 is an aluminum alloy brake disc body 1. The aluminum alloy brake disc body 1 includes an outer brake disc body 11 and an inner brake disc body 12, and the outer brake disc body 11 and the inner brake disc body 12 are connected through a connecting rib 13. The working surfaces of the outer brake disc body 11 and the inner brake disc body 12 are each attached with a wear-resistant layer 2 with the thickness 11 mm, the wear-resistant layers 2 are made of ceramic high-temperature resistant MMC reinforced materials, and the wear-resistant layers 2 made of ceramic high-temperature resistant MMC reinforced materials metallurgically bond with the aluminum alloy brake disc body 1 through the squeeze casting technique.

In the second embodiment, the two wear-resistant layers 2 are each in the shape of a plate formed by a plurality of sub-plates which are spliced together. The two wear-resistant layers 2 are connected up and down through a supporting rib. The supporting rib is made of high-temperature resistant skeleton metal materials. The two wear-resistant layers 2 are metallurgical bond with the aluminum alloy brake disc body 1 through the squeeze casting technique. The supporting rib includes a plurality of supporting units 3. The upper portion and the lower portion of each supporting unit 3 are each integrally provided with a plurality of connecting tips 31. A plurality of insertion holes 21 matched with the multiple connecting tips 31 are formed in the two wear-resistant layers 2. Each connecting tip 31 is inserted in one insertion hole 21. The multiple supporting units 3 are arranged at intervals in the circumferential direction of the two wear-resistant layers 2.

In the second embodiment, the ceramic high-temperature resistant MMC reinforced material is prepared from ceramic fiber materials, high-temperature resistant skeleton metal materials and ceramic particle materials, and the mass ratio of the ceramic fiber materials, the high-temperature resistant skeleton metal materials and the ceramic particle materials is 10:40:45. The ceramic fiber materials include one or more of alumina fibers, alumina silicate fibers, silicon dioxide fibers, zirconium oxide fibers, silicon carbide fibers, graphite fibers and carbon fibers. The high-temperature resistant skeleton metal materials are high-temperature resistant metal fibers including one or more of fe-based alloy fibers, nickel-based alloy fibers, copper-based alloy fibers, stainless steel fibers, steel wool fibers, titanium-based alloy fibers and cobalt-based alloy fibers. The ceramic particle materials include one or more of flyash particles, superfine slag powder particles, silicon carbide particles, silicon dioxide particles, boron nitride particles, zircon powder particles, brown fused alumina particles, zirconium oxide particles, zirconium silicate particles and chromic oxide particles. Auxiliary reinforcing particles are mixed in the ceramic particle materials and are graphite particles and/or steel slag particles. The steel slag particles can be one or more of iron oxide particles, zinc oxide particles, calcium oxide particles, magnesium oxide particles, aluminum oxide particles and titanium oxide particles. The diameter of the ceramic fiber materials is 5-15 μm, and the length of the ceramic fiber materials is 0.8-2.8 mm. The diameter of the high-temperature resistant metal fibers is 0.01-2 mm. The granularity of the ceramic particle materials is 5-200 μm, and the Mohs hardness of the ceramic particle materials is 5-9.

The manufacturing method of the ventilated automotive brake disc includes the following steps:

1) Raw materials are prepared, specifically, dry ceramic fiber materials, high-temperature resistant skeleton metal materials and ceramic particle materials are prepared according to the mass ratio 10:40:45.

2) High-temperature resistant skeleton metal preforms are manufactured, specifically, high temperature resistant fibers are evenly spread in a mold matched with the wear-resistant layers in shape and size in twice and then compacted, and thus the two High-temperature resistant skeleton metal preforms are obtained.

3) Preforms of the wear-resistant layers made of ceramic high-temperature resistant MMC reinforced materials are manufactured as follows, the High-temperature resistant skeleton metal preforms obtained in Step 2) are placed in a preform mold, the ceramic fiber materials and the ceramic particle materials prepared in Step 1) are evenly mixed with a low-temperature binding agent and a high-temperature binding agent according to the mass ratio 10:40:2:3, and thus ceramic slurry is obtained, wherein the low-temperature binding agent is a carboxymethylcellulose aqueous solution with the concentration 20%, and the high-temperature binding agent is a silica sol solution with the concentration 50%; the obtained ceramic slurry is then poured into the preform mold, the preform mold is pressurized to 30 MPa and vacuumized to 1*10⁻² Pa, and then semi-finished preforms of the wear-resistant layers made of ceramic high-temperature resistant MMC reinforced materials are formed through dewatering and pressing; and afterwards, the semi-finished preforms are dried at the temperature of 150° C. for 10 h and sintered at the temperature of 900° C. for 2.5 h, and thus the finished preforms of the wear-resistant layers made of ceramic high-temperature resistant MMC reinforced materials are obtained.

4) The finished preforms of the wear-resistant layers made of ceramic high-temperature resistant MMC reinforced materials obtained in Step 3) are placed in the lower mold part of a squeeze casting mold, then aluminum alloy is smelted, the molten aluminum alloy is then poured into the lower mold part of the squeeze casting mold matched with the brake disc in size and shape, afterwards, the upper mold part and the lower mold part of the squeeze casting mold are assembled for squeeze casting at the pressure 120 MPa, the temperature of the upper mold part and the lower mold part is 210° C., the pressure is maintained for 45 seconds after the upper mold part and the lower mold part are assembled, then the mold is opened, and a brake disc casting is taken out of the mold and obtained.

5) The brake disc casting obtained in Step 4) is subjected to solution treatment at the temperature 500° C. and kept at the temperature for 7 h, the brake disc casting is then quenched in water at the temperature over 60° C., and finally the brake disc casting is subjected to aging treatment at the temperature 150° C. and kept at the temperature for 7 h, and thus a semi-finished brake disc is obtained.

6) The semi-finished brake disc is machined, specifically, the finished ventilated automotive brake disc is manufactured after the semi-finished brake disc is machined according to drawing requirements.

In the above embodiments, the patent with the application No. CN201510405158.1 can provide references for the manufacturing method of the brake disc.

1. A brake disc is used for brake systems of motor vehicles, rail vehicles and aircrafts, the brake disc comprises a brake disc body, wherein the brake disc body is an aluminum alloy brake disc body, the two working surfaces of the aluminum alloy brake disc body are respectively attached with a wear-resistant layer, wherein the wear-resistant layers are wear-resistant layers made of ceramic high-temperature resistant metal matrix composite (MMC) reinforced materials, and the wear-resistant layers made of ceramic high-temperature resistant MMC reinforced materials metallurgically bond with the aluminum alloy brake disc body through a squeeze casting technique; a composition of the ceramic high-temperature resistant MMC reinforced material comprises ceramic fiber materials, high-temperature resistant skeleton metal materials and ceramic particle materials with the mass ratio of (1-30):(10-60):(10-70); the ceramic fiber materials comprise one or more of alumina fibers, alumina silicate fibers, silicon dioxide fibers, zirconium oxide fibers, silicon carbide fibers, graphite fibers and carbon fibers; the high-temperature resistant skeleton metal materials are foam metal or high-temperature resistant metal fibers; the high-temperature resistant metal fibers comprise one or more of iron-based alloy fibers, nickel-based alloy fibers, copper-based alloy fibers, stainless steel fibers, steel wool fibers, titanium-based alloy fibers and cobalt-based alloy fibers; the ceramic particle materials comprise one or more of flyash particles, superfine slag powder particles, silicon carbide particles, silicon dioxide particles, boron nitride particles, zircon powder particles, brown fused alumina particles, zirconium oxide particles, zirconium silicate particles and chromic oxide particles.

2. The brake disc according to claim 1, wherein two layers of the wear-resistant are respectively in the shape of an integrated plate or in the shape of a plate formed by a plurality of sub-plates which are spliced together; two layers of the wear-resistant layers are connected up and down through a supporting rib; the supporting rib is made of high-temperature resistant skeleton metal materials; two layers of the wear-resistant layers and the supporting rib metallurgically bond with the aluminum alloy brake disc body through the squeeze casting technique.

3. The brake disc according to claim 2, wherein the supporting rib comprises a plurality of supporting units; the upper portion and the lower portion of each supporting unit are integrally provided with a plurality of connecting tips respectively; a plurality of insertion holes, matched with the plurality of connecting tips, are formed in two layers of the wear-resistant layers; each connecting tip is inserted into one insertion hole; the plurality of supporting units are arranged at intervals in the circumferential direction of two layers of the wear-resistant layers.

4. The brake disc according to claim 2, wherein the aluminum alloy brake disc body is a ventilated brake disc body and the aluminum alloy brake disc body comprises an outer brake disc body and an inner brake disc body; the outer brake disc body and the inner brake disc body are connected through a connecting rib; the working surfaces of the outer brake disc body and the inner brake disc body are respectively attached with one layer of the wear-resistant layer.

5. The brake disc according to claim 1, wherein auxiliary reinforcing particles are mixed in the ceramic particle materials, and the auxiliary reinforcing particles are graphite particles and/or steel slag particles.

6. The brake disc according to claim 5, wherein the steel slag particles are one or more of iron oxide particles, zinc oxide particles, calcium oxide particles, magnesium oxide particles, aluminum oxide particles and titanium oxide particles.

7. The brake disc according to claim 1, wherein the foam metal is foam copper, foam iron, foam nickel or foam iron-nickel.

8. The brake disc according to claim 1, wherein the ceramic fiber materials have the diameter of 5-15 μm and the length of 0.8-2.8 mm; the high-temperature resistant metal fibers have the diameter of 0.01-2 mm; the ceramic particle materials have the granularity of 5-200 μm and the Mohs hardness of 5-9; the foam metal has the porosity of 10-60 ppi.

9. The brake disc according to claim 1, wherein the thickness of the wear-resistant layers is 2-15 mm.

10. The brake disc according to claim 1, wherein squeeze casting is replaced with environment-friendly sand mold casting, vacuum die casting, centrifugal casting, low pressure casting, differential pressure casting, metal mold casting, investment casting, lost foam casting or vacuum suction casting.

11. A manufacturing method of a brake disc, comprising the following steps:
1) Raw materials preparation: by mass fraction, dry ceramic fiber materials, high-temperature resistant skeleton metal materials and ceramic particle materials are prepared according to the mass ratio of (1-30):(10-60):(10-70);
2) Manufacture of high-temperature resistant skeleton metal preforms: foam metal is machined into two plates which are matched with the wear-resistant layers in shape and size, so that the high-temperature resistant skeleton metal preforms are obtained; or high-temperature resistant metal fibers are evenly spread in a mold matched with the wear-resistant layers in shape and size in twice and then compacted, so that two high-temperature resistant skeleton metal preforms are obtained;
3) Manufacture of preforms of the wear-resistant layers made of ceramic high-temperature resistant MMC reinforced materials: the high-temperature resistant skeleton metal preforms obtained in Step 2) are placed in a preform mold, the ceramic fiber materials and the ceramic particle materials prepared in Step 1) are evenly mixed with a low-temperature binding agent and a high-temperature binding agent according to the mass ratio (1-30):(10-70):(0.5-8):(0.5-10), and thus a ceramic slurry is obtained, wherein the low-temperature binding agent is a carboxymethylcellulose aqueous solution with the concentration of 3-20%, and the high-temperature binding agent is a silica sol solution with the concentration of 10-60%; the obtained ceramic slurry is then poured into the preform mold, the preform mold is pressurized to 20-30 MPa and vacuumized to 1*10-2 Pa, and semi-finished preforms of the wear-resistant layers made of ceramic high-temperature resistant metal composite reinforced materials are formed through dewatering and pressing; and afterwards, the semi-finished preforms are dried at the temperature of 60-200° C. for 10-20 h and sintered at the temperature of 700-1000° C. for 2.5-4 h, and thus finished preforms of the wear-resistant layers made of ceramic high-temperature resistant metal composite reinforced materials are obtained;
4) The finished preforms of the wear-resistant layers made of ceramic high-temperature resistant MMC reinforced materials obtained in Step 3) are placed in the lower mold part of a squeeze casting mold, then aluminum alloy is smelted, the molten aluminum alloy is then poured into the lower mold part of the squeeze casting mold matched with the brake disc in size and shape, afterwards, the upper mold part and the lower mold part of the squeeze casting mold are closed for squeeze casting at the pressure of 50-150 MPa, the temperature of the upper mold part and the lower mold part is 100-250° C., the pressure is maintained for 10-60 seconds after the upper mold part and the lower mold part are assembled, then the mold is opened, and a brake disc casting is taken out of the mold and obtained;
5) The brake disc casting obtained in Step 4) is subjected to solution treatment at the temperature of 480-535° C. and kept at the temperature for 5-7 h, the brake disc casting is then quenched in water at the temperature over 60° C., and finally the brake disc casting is subjected to aging treatment at the temperature of 150-180° C. and kept at the temperature for 4-8 h, and thus a semi-finished brake disc is obtained;
6) Machining of the semi-finished brake disc: the finished brake disc is manufactured after the semi-finished brake disc is machined according to drawing requirements.
